(19) United States
(12) Patent Application Publication
(10) Pub. No.: US 2010/0169117 A1
(43) Pub. Date: Jul. 1, 2010

(54) System and Methods For Managing Medication The Administration of A Plurality of Patients

(76) Inventor: Benoit Demers, St-Jean-Chrysostome (CA)

Correspondence Address: DOWELL & DOWELL P.C., 103 Oronoco St., Suite 220, Alexandria, VA, 22314, US

(21) Appl. No.: 12/087,868

(22) PCT Filed: Jan. 12, 2007
(86) PCT No.: PCT/CA2007/000053

§ 371 Date: Apr. 28, 2009

(30) Foreign Application Priority Data
Jan. 17, 2006 (FR) 2.532.072

(51) Int. Cl. G06Q 50/00; B42F 21/12; B42F 17/06; G06Q 90/00

(52) U.S. Cl. 705/3; 283/3; 283/115; 705/500

(57) ABSTRACT

The present invention concerns a system and methods for managing the administration of medication to a plurality of patients who are simultaneously lodged in an institution. The system comprises an information file card which corresponds to each and all patients and a support on which the information file cards may be placed. The method comprises the steps of: providing an information file card for each of the patients; providing a support on which a plurality of information file cards can be placed simultaneously; and arranging the information file cards on the support, in such a manner so as to obtain, in a single display, a quick overview of the medication to be administered to the whole group of patients.

### TECHNICAL FIELD OF THE INVENTION

The present invention relates to a method for managing the administration of medication to a plurality of patients, and a system and display in keeping with the method.

### DESCRIPTION OF THE PRIOR ART

The development of day care centers during the last decades has led to the adoption of regulations aimed at controlling certain aspects of these day care centers, for example the administration of medication to children. To comply with these legislative requirements, day care centers tend to adopt rules which ensure the proper administration of medication to their young patients.

Some systems aimed at helping to manage the administration of medication have been described in the prior art. For example, United States Patent Application Publication No. 2004/0188998 describes a reminder device for the taking of a medication, and a method related to this device. The information relating to the medication for a patient is computer generated and is printed in the form of a schedule. The schedule may be affixed to a medication container, inserted into the box containing the medication or can simply be given to the patient.

U.S. Pat. No. 5,758,096 describes a computerized system which makes it possible to generate a display for the management of medication administration. The data relative to the medication for one or more patients are kept in the same computerized database and are used to generate a chart which displays various information concerning the various medication and the different periods of the day. This system also comprises labels provided with different symbols, these labels being affixed on the container of corresponding medication. All the charts or labels are specific to a patient.

U.S. Pat. No. 5,431,450 describes a chart which displays the medication for a patient, its dosage and the time when it must be taken. This chart also comprises a place to be used for taking notes and a tray for storing the medicine in one central location. The chart is specific to a patient.

U.S. Pat. No. 5,031,937 describes a pictogram system intended to facilitate the administration of medication to a patient. This system is based on the application of self-adhesive stickers which correspond to a specific medication on a chart, the latter comprising spaces corresponding to different periods of the day.

The prior art systems, methods or charts that allow the administration of medication to be managed tend not to allow information concerning the administration of medication to a plurality of patients sourced from independent databases, to be generated onto a single display. Thus, it would be advantageous to have a system which permits the administration of medication to a plurality of patients to be managed simultaneously, and which has information concerning all the patients on a single display. It would be further advantageous if such a system permitted data concerning each patient to be generated from different databases.

### SUMMARY

According to an embodiment of the present invention, there is provided a method for managing the periodic administration of medication to patients who are treated in the same institution. The method comprises the following steps: (1) providing an information file card for each patient; (2) providing a support on which the information file cards can be arranged; and (3) placing the information file cards on the support. Each information file card is divided into cells, each of them corresponding to a time interval. Each cell displays information concerning the administration of medication to the patient during this time interval. The information file cards are placed on the support to define a matrix having rows and columns. The rows or columns of the matrix are defined by the cells of each information file card.

According to another embodiment of the present invention, there is provided a system for managing the periodic administration of medication to a plurality of patients. The patients are lodged in the same institution and are under the supervision of a limited number of persons who are in charge of administrating the medication. The system comprises a support for information file cards on which a plurality of information file cards can be arranged. The information file cards may be aligned on the support in such a way that they define a matrix having rows and columns.

The system is provided with information file cards. Each information file card corresponds to one specific patient. Each information file card is divided into a plurality of cells. Each cell corresponds to a time interval and displays information relevant to the administration of medication to the patient for this time interval. The cells of each information file card for each patient define the rows and columns of the matrix when the information file cards are placed on the support.

According to yet another embodiment of the present invention, there is provided a display for managing the periodic administration of medication to a plurality of patients lodged in a same institution. The display comprises information file cards and a support on which information file cards can be arranged. The information file cards may be arranged on the support to define a matrix. Each information file card corresponds to one particular patient and is divided into a plurality of cells. Each cell corresponds to a time interval and display information concerning the administration of medication to the patient for this time interval. When they are placed on the support, the information file cards define the rows and columns of the matrix.

### BRIEF DESCRIPTION OF THE DRAWINGS

The embodiments of the present invention would be more clearly understood by referring to the detailed description of embodiments of the invention in conjunction with the accompanying drawings, in which:

FIG. 1 is a front perspective view of a system according to one embodiment of the present invention;

FIG. 2 is a front view of the system shown in FIG. 1;

FIG. 3 is a front view of the support in accordance with one embodiment of the present invention;

FIG. 4 is a side view of the support shown in FIG. 3;

FIG. 5 is a front perspective view of a support in accordance with another embodiment of the present invention;

FIG. 6 is a front view of the support shown in FIG. 5;

FIG. 7 is a front view of a main file card in accordance with an embodiment of the present invention;

FIG. 8 is a front view of the main file card similar to the one illustrated in FIG. 7, showing the indexable file card separated from the information file card;

FIG. 9 is a front view of the information file card shown in FIG. 8; and

FIG. 10 is a diagram which illustrates a method in accordance with one embodiment of the present invention.

### DESCRIPTION OF EMBODIMENTS OF THE INVENTION

The description which follows and the embodiments described herein, are given by way of illustration of one or more example(s) of embodiments of principles and aspects of the present invention. These examples are provided for the purpose of explaining and not for limiting the principles of the invention. In the description which follows, the parts or steps of the system or of the methods are identified by reference numerals, which are also used in the drawings to designate the same parts or steps.

Generally speaking, the system 20 is aimed at facilitating the management of medication administration to a plurality of patients, said patients being lodged in an institution for a given period of time. The system 20 facilitates managing the administration of medication in that it is simple, reliable, safe, and makes it possible to have a quick overview of all the medication to be administered to the patients. The system 20 makes it possible to obtain on a same display, information concerning the administration of medication to all the patients, which display may be generated from different databases.

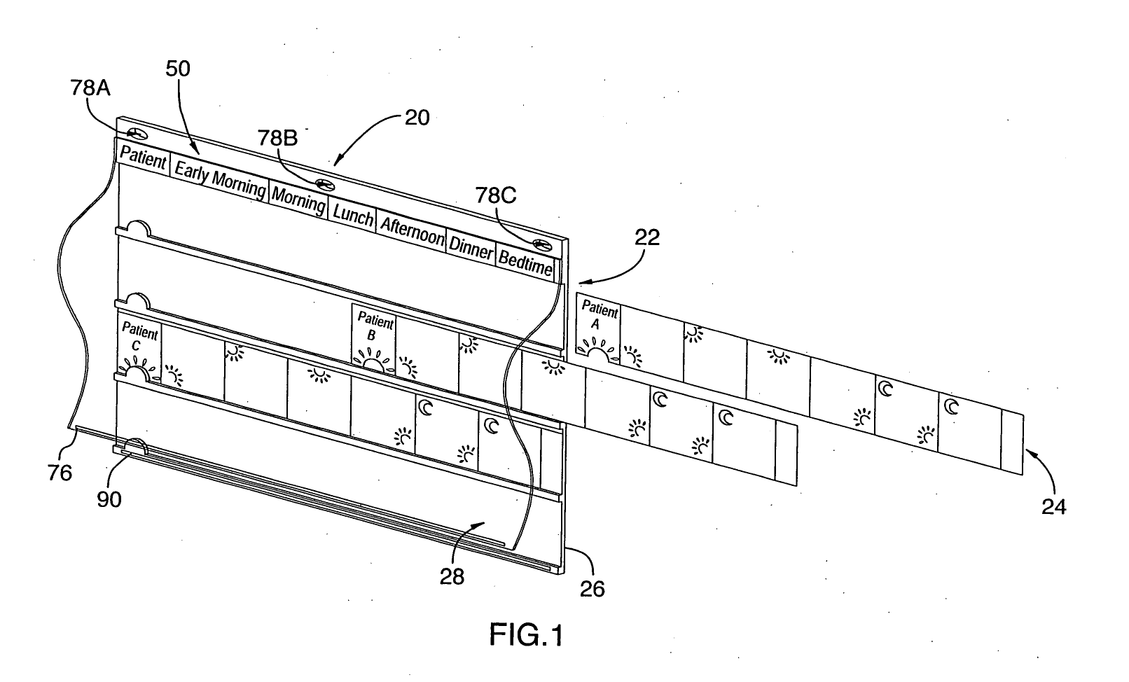

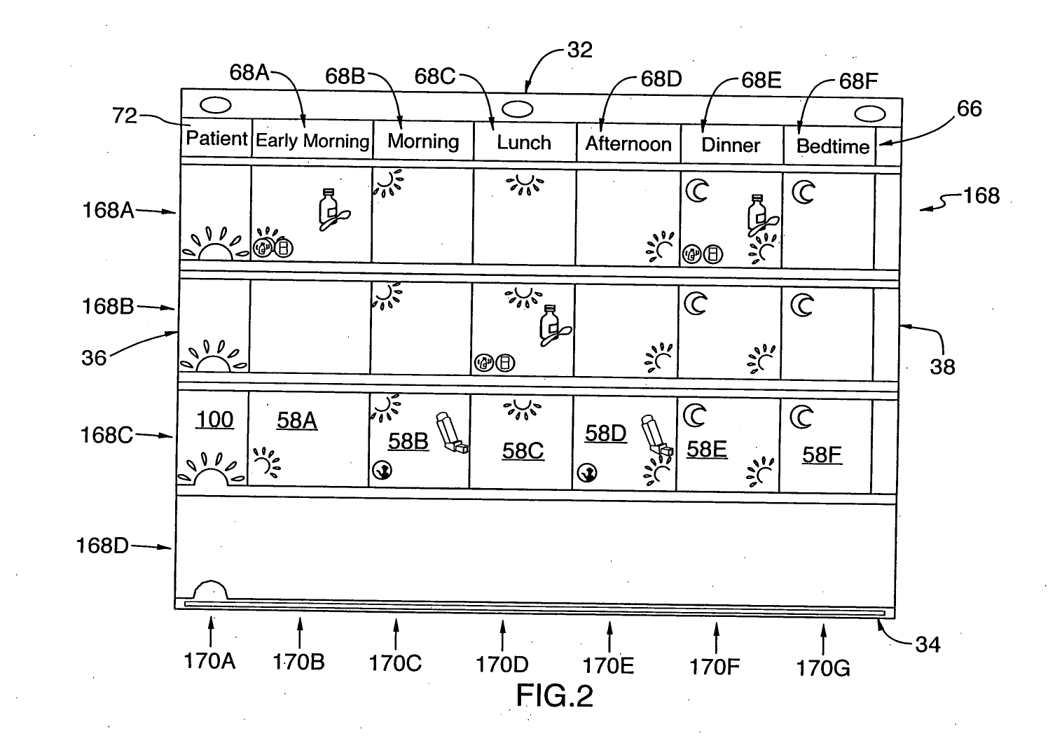

FIGS. 1 and 2 show a system for managing the administration of medication to a plurality of patients, designated by reference numeral 20. In a preferred embodiment, the system 20 includes an information file card support 22 and the information file cards 24 which are intended to be disposed thereon. The support 22 is designed to simultaneously receive a plurality of information file cards which correspond to a plurality of patients. Each information file card 24 displays information concerning the administration of a medication to the patient. A medication which is administered to a patient in accordance with the system, is understood to mean a medicine or any substance or composition having therapeutic, prophylactic, curative or preventive properties, whether the medication is sold under prescription or not, including without limitation, a medicine, a natural product, a vitamin or a combination thereof, in the form of capsule, tablet, syrup, or aerosol.

According to one embodiment, the patients to which the medication are administered include children, preferably less than 18 years old, or more preferably, children less than 12 years old. The patients are lodged in a same institution in which the administration of the medication to all the children, is in the hands of a limited number of persons in charge. This institution may be a nursery, a childcare centre, a day-care centre or a school. According to an alternative embodiment, the system may be used in any other type of institution in which a plurality of patients are lodged for a given period of time and where the administration of the medication to all the patients lodging therein is in the hands of a limited number of persons in charge. The system may therefore be used for the management of medication administration to patients who are not sufficiently autonomous to self-administer the medication, whether they are human patients or non-human patients. The patients therefore include, but are not limited to, persons with illnesses, seniors, prisoners and animals. By way of example, the system could be used in a school, a vacation camp, a play ground, long-term care centres for older persons, a geriatric centre, a hospital or a detention centre. Alternately, the system could be used on a farm, a zoo, a pension for animals, a veterinary hospital or any location in which there are a plurality of animals which require the administration of medication.

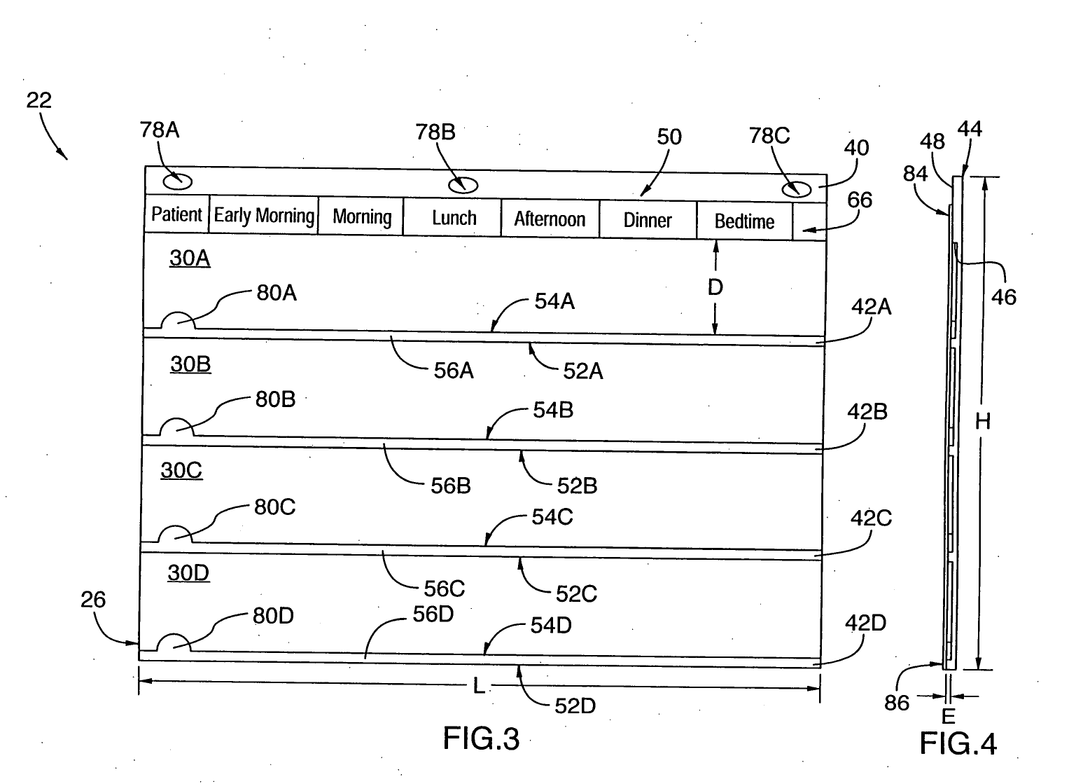

Now, referring to FIGS. 1 and 2, the support 22 comprises a plate 26 and a transparent cover 28. The support 22 also comprises a series of seats 30A to 30D defined on the plate 26, which make it possible to place and maintain information file cards 24 on the support 22 (FIG. 3).

The plate 26 is generally in the shape of a rectangle defined by an upper end 32, a lower opposite end 34, a left side end 36 and a right side end 38. Side ends 36 and 38 are generally perpendicular to the upper and lower ends 32 and 34 and define therebetween a width L. A height H is defined between the upper and lower ends 32 and 34 of the plate 26 (FIG. 3). The dimensions H and L of the plate 26 correspond to those of a sheet of paper of a Letter format (216 by 279 mm or 8½ by 11 inches) to facilitate its storage in a loose leaf binder of standard format, as will be described in detail hereinafter. Alternatively, the size of the plate 26 may correspond to the dimensions of an A4 sheet of paper. Obviously, the plate 26 may be of different size to comply with the needs of the user. The plate 26 is preferably made of a plastic material or any other suitable material and may be rigid or semi-rigid.

The plate 26 comprises a series of longitudinal projections 40 and 42A-42D, which are spaced from one another and extend in parallel relationship with respect to the upper and lower ends 32 and 34, between the side ends 36, 38. Preferably, the longitudinal projections 40 and 42A-42D are made of a plastic material and define an integral structure with the plate 26. The projections 40 and adjacent projections 42A-42D define therebetween seats 30A-30D of height D. Each seat 30A-30D can receive the information file card 24 of a patient. A perforated section 50 provided at the upper end 32 of the plate 26 makes it possible to place support 22 in a loose leaf binder (not shown).

The projection 40 is defined by a upper side 44, which is perpendicular to the plane of the plate 26, a lower side 46, which is opposite upper side 44, and a front face 48. The front face 48 is generally parallel to the plane of the plate 26 and connects the upper and lower sides 44 and 46. The projection 40 has a thickness E, which is adapted to the thickness of information file cards 24.

Since longitudinal projections 42A-42D are generally of similar dimension and size, it will be sufficient to describe in detail only one projection 42A for the purpose of the present disclosure. The projection 42A is defined by a lower side 52A, which is generally linear, and perpendicular to the plane of the plate 26, an upper side 54A, opposite lower side 52A and a front face 56A, which is parallel to the plane of the plate 26. The front face 56A connects upper and lower sides 54A and 52A. The projections 42A-42D have a thickness E (FIG. 4), which is adapted to the thickness of information file cards 24.

The first projection 40 is generally located at the upper end 32 of plate 26. An identification band 66 is fixed to front face 56 of the first projection 40. The identification band 66 is divided into a plurality of cells, each of which represents various time periods of the day. In a preferred embodiment, identification band 66 is divided into six cells 68A-68F which represent the early morning 68A, the morning 68B, the lunch 68C, the afternoon 68D, the dinner 68E, and the bedtime 68F intervals. Cells 68A-68F are distributed in chronological order from left to right. Each cell 68A-68F of the identification band 66 has a specific color which is significantly distinct from that of an adjacent cell, thereby allowing a user to rapidly and visually distinguish each period of the day. The color of each cell 68A-68F is adapted to match the color of cells 58A-58F of the information file cards 24 which correspond to the same time periods, as will be described in detail hereinafter.

Preferably, the identification band 66 contains an additional cell 72, which is located at the left of the cell corresponding to the early morning period 68A. This additional cell 72 may be used to display the business logo, the name of the person who is responsible for the administration of the medication, a note allowing someone to identify the fact that the column is the one of the patients, or any other information of general nature. A technician skilled in the art will understand that identification band 66 may be adapted depending on the needs associated with the administration of medication. For example, identification band 66 may be modified to display different periods of the day, of the week, the month, of the year, or any other period of time suitable and during which a patient can receive a medication.

A second projection 42D is located at the lower end 34 of the plate 26. The third, fourth and fifth projections 42A-42C, respectively, are uniformly distributed between the first and second projections 40 and 42D, to define therebetween four seats 30A-30D. The shape and dimensions of each projection 42A-42C are similar to those of the second projection 42D.

The seats 30A-30D are generally uniform in shape and size, so that it will be sufficient to describe only one seat 30A in detail for the purposes of the present disclosure. The seat 30A is delineated by the upper side 54A of the projection 42A and by the lower side 46 of the adjacent projection 40. The distance D which separates projections 40 and 42A defining the seat 30A is adapted to receive an information file card 24.

The upper side 54A of projection 42A preferably has an irregular surface in that it comprises at least one elevation 80A which projects in the seat 30A. The elevation 80A collaborates with a notch 88 of the information file card 24 to prevent its lateral displacement when it is placed on the support 22, as will be described in detail hereinafter. The elevation 80A preferably defines an integral structure with the projection 42A of the plate 26 and is preferably shaped as a half-circle. A qualified technician will however understand that the number, the shape and the position of elevation(s) 80A may vary, while maintaining its functionality. For example, an elevation 80A having two sides and generally defining the shape of a chevron could be used. Alternatively, elevation 80A could be associated with the lower side of a projection.

The perforated section 50 of the plate 26 is generally shaped as a rectangle which is defined by the upper side 44 of the projection 40, the identification band 66 and the side ends 36 and 38 of the plate 26. The perforated section 50 preferably includes a series of three perforations 78A-78C, each perforation 78A-78C being located and adapted to receive one of the rings of a loose leaf binder of standard format so as to allow someone to store the system 20. According to an alternative embodiment, the system 20 could comprise a different device for storing it. By way of example, the lower end 34 of the plate 26 could be secured to a base making it possible to place the support 22 on a horizontal surface, such as a table or a countertop. According to an alternative embodiment, the support 22 could comprise magnetized bands allowing someone to fix the support on a vertical surface, such as the door of a refrigerator. A technician skilled in the art will understand that support 22 can be adapted in any other manner so that a person in charge of administering the medication can place system 20 in a place which is readily accessible.

According to the preferred embodiment, support 22 comprises a cover 28 (FIG. 1). The cover 28 is preferably a transparent cover allowing the person in charge of administering the medication to visualize the information file cards 24 placed in the support 22 when the cover 28 is in closed position, such as will be described hereinafter. The cover 28 is a flexible cover in that it can be opened or closed without requiring the presence of hinges. The cover 28 has the general shape of a rectangular sheet of transparent polymer material having the same dimensions as the plate 26. The cover 28 has an upper end 84 and a lower end 86. The upper end 84 of the cover 28 is fixedly attached to the projection 40 of the plate 26, all along width L, by means of an adhesive, such as a glue material. In the embodiment, lower end 86 of the cover 28 cooperates with the lower end 34 of the plate 26 to permit closing of the cover 28 in a manner to keep the information file cards 24 in place. For this purpose, the cover 28 may be provided with a fastener 76 which is compatible with a complementary fastener 90 located on the projection 42D of the plate 26, such as a fastener of the Velcro™ type, by means of which it is possible to removably fasten the lower end 86 of the cover 28 to the lower end 34 of the plate 26.

When the lower end 34 of the plate 26 is fixed to the lower end 86 of the cover 28 by means of the fastener 76 and the complementary fastener 90, the cover 28 covers all the projections 42A-42D and seats 30A-30D and prevents any access to the information file cards 24, by keeping them in place. When the fastener 76 is detached from the complementary fastener 90, the lower end 86 of the cover 28 may be raised to uncover the seats 30A-30D for the placement and removal of the information file cards 24. Once the information file cards 24 are placed or removed from the seats 30A-30D, the cover 28 may be pulled down on the plate 26. A technician skilled in the art will however recognize that cover 28 may function in a different manner and the present example is only an illustration. In an alternative example, cover 28 could be a cover made of plexiglass which is fixed to plate 26 by means of hinges.

Alternatively, a qualified technician could replace the cover 28 with another device allowing the information file cards 24 to be maintained in place when they are placed on support 22. By way of example, each seat 30A-30D could be provided with an adhesive band, a Velcro™ band or a magnetized band which is associated with a complementary band fixed on the back of an information file card 24. Also, each of the side ends 36 and 38 of the plate 26 could be provided with a system of hooks allowing an information file card 24 to remain in place when it is inserted in the hooks.

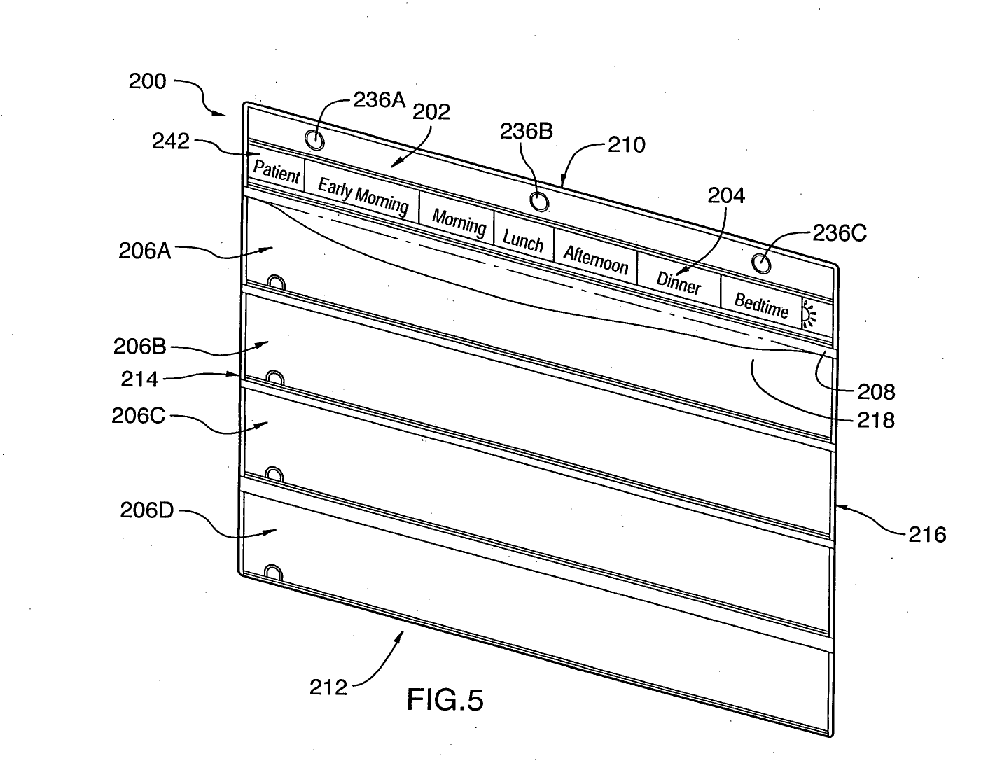

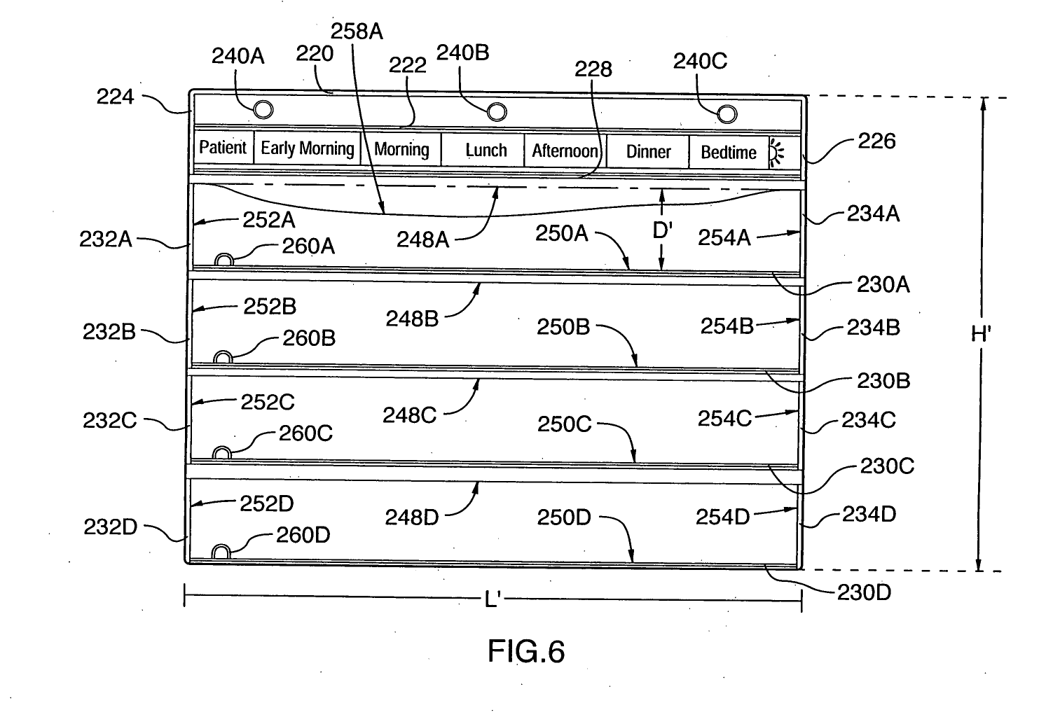

Although, in the preferred embodiment, the seats 30A-30D are defined by projections 40, 42A-42D which are integral with the plate 26, there are other ways to design a support on which information file cards 24 can be arranged. For example, an alternative support could be made of two portions which cooperate to define pockets capable of receiving the information file cards 24. Such a support, referred to by reference numeral 200, is illustrated in FIGS. 5 and 6.

The support 200 comprises a first portion 208 defining the base of support 200. The first portion 208 has the general shape of a rectangle defined by an upper end 210, an opposite lower end 212, a left side end 214 and a right side end 216. The side ends 214 and 216 are generally perpendicular to the upper and lower ends 210 and 212 and define therebetween a width L′. A height H′ is defined between the upper and lower ends 210 and 212 of the first portion 208. The dimensions H′, and L′, of the first portion 208 correspond to those of sheet of paper of Letter format (216 by 279 mm or 8½ by 11 inches) in order to make it possible to place it in a standard loose leaf binder. Alternatively, the first portion 208 may have the dimensions of an A4 sheet of paper. Obviously, the first portion 208 may be dimensioned differently to comply with the needs of the user. The first portion 208 is preferably made of a plastic material or another suitable material and may be rigid or semi-rigid.

A second portion 218 is associated with the first portion 208 by means of a series of joints 220-234. The second portion 218 is associated with first portion 208 and joints 220-234 to define a perforated section 202, an identification band 204 and a series of pockets 206A-206D for displaying the information file cards 24. The second portion 218 is preferably made of a transparent polymer allowing the person in charge of administering the medication to visualize the information file cards 24 placed on the support 200. The joints 220-234 allow the first portion 208 and the second portion 218 to be associated with one another. Each joint 220-234 is obtained by welding the second portion 218 with the first portion 208. Alternatively, the first portion 208 and the second portion 218 could be joined to one another in any suitable manner, including without limitation by gluing.

The perforated section 202 of support 200 has the general shape of a rectangle defined by a first joint 220, a second joint 222 and two lateral joints 224 and 226. The first joint 220 is located at the upper end 210 of the first portion 208. The second joint 222 is located in an intermediate region 238 between the upper end 210 and the center of support 200. The first and second joints 220 and 222 extend between the side ends 214 and 216, all along width L′. The lateral joints 224 and 226 are located on either sides of the perforated section 202, at each side end 214 and 216 thereof, and extend between first joint 220 and a third joint 228, which will be described hereinafter.

The perforated section 202 of support 200 is similar to the perforated section 50 of the plate 26 in that it has the same functions and preferably includes a series of three perforations 236A-236C. Perforations 236A-236C are located and adapted to receive the rings of a loose leaf binder of standard format to allow for the storage of system 20. Each perforation 236A-236C is surrounded by a circular joint 240A-240C. The joints allow the first portion 208 and the second portion 218 to remain associated with one another when inserting support 200 in a loose leaf binder.

The identification band 204 is located between perforated section 202 and the center of the first portion 208. The identification band 204 is defined by the second joint 222, the third joint 228 and the lateral joints 224 and 226. The third joint 228 extends between side ends 214 and 216, all along width L′. Together, joints 222, 224, 226 and 228 define a rectangular shape.

The first and second portions 208 and 218 of the identification band 204 enclose an identification label 242. Identifications label 242 is similar to the identification band 66 in that is it divided into a plurality of cells, each one representing a period of the day. The label 242 is preferably printed on paper after which it can be enclosed between the first and second portions 208 and 218. Joints 222, 224, 226 and 228 ensure that the label 242 is retained between the first and second portions 208 and 218. Alternatively, joints 226 or 228 could be opened to allow for the removal of the identification label 242.

The pockets 206A-206D are uniformly distributed between the identification band 204 and the lower end 212. Since the pockets 206A-206D are generally of uniform shape and dimension, it will be sufficient to describe only one pocket 206A in detail for the purpose of the present disclosure.

The pocket 206A comprises an upper edge 248A, a lower edge 250A and two lateral edges 252A and 254A. A distance D′ separates upper edge 248A from lower edge 250A, this dimension being sufficient to receive an information file card 24.

First and second portions 208 and 218 are dissociated from one another at the level of upper edge 248A of pocket 206A, so as to define an opening 258A. The opening 258A allows the person in charge of administering the medication, to place an information file card 24 in the pocket 206A, between the first and second portions 208 and 218. Optionally, the pocket 206A may comprise a semi-circular joint 260A. The semi-circular joint 260A is adjacent the fourth joint 230A and collaborates with the semi-circular notch 88 of the information file card 24 to keep it in position, as it will be described in detail hereinafter. A qualified technician will however recognize that the number, the shape and the position of joint(s) 260A-260D could vary, while preserving their functionality.

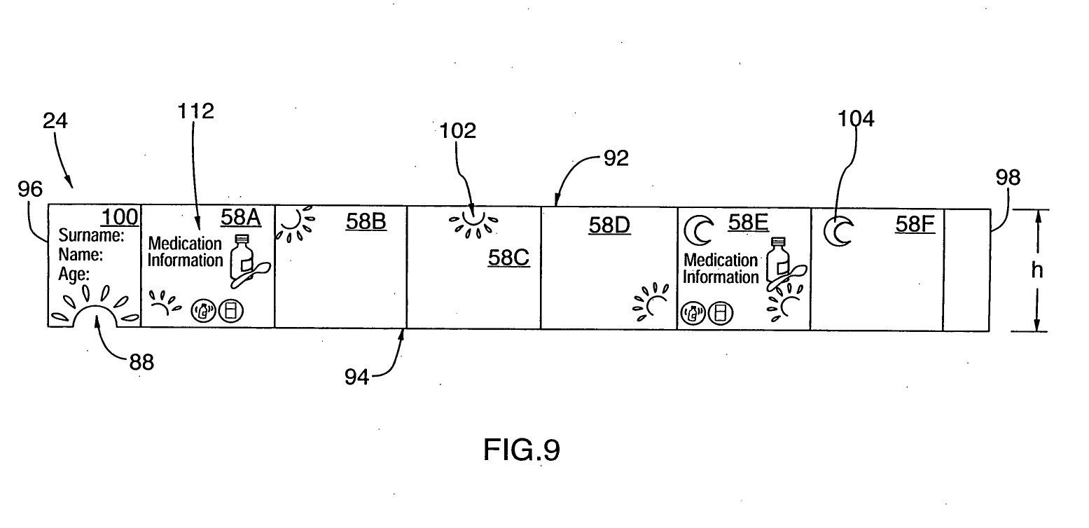

Referring now to FIG. 9, the information file card 24 is of the general shape of a rectangular strip defined by an upper edge 92, a lower edge 94 and two side edges 96 and 98. The upper and lower edges 92 and 94 of the information file card 24 define a height h corresponding to distance D, in a manner to minimize displacement of information file card 24 between two adjacent projections, for example projections 42B and 42C defining seat 30B of the support 22. Alternatively, height h could correspond to distance D′ of the pockets 206A-206D. The side edges 96 and 98 of the information file card 24 define a width which substantially corresponds to width L or L′ of supports 22 and 200, respectively.

The information file card 24 is preferably made of paper, although this material could be replaced by any other suitable material, including, but not limited to, cardboard or plastic. The upper edge 92 of the card 24 is preferably linear, while lower edge 94 is irregular in that it comprises a concave notch 88. With respect to the support 22, the notch 88 is preferably in the shape of a half-circle, whose dimensions are adjusted to cooperate with a corresponding portion formed either in each projection 42A-42D of support 22, i.e. elevations 80A-80D, or in each pocket 206A-206D of support 200, i.e. joints 260A-260D. The notch 88 is located in such a manner that, when the information file card 24 is placed, for example, in the seat 30B and the elevation 80B of the projection 42b extends into the notch 88, the lateral edges 96 and 98 of the information file card 24 are aligned with the side ends 36 and 38, respectively, of the plate 26. A qualified technician will however recognize that the number, shape and position of the notch(es) 88 can vary and be adapted so as to allow the information file card 24 to fit into seats 30A-30D and cooperate with elevation(s) 80A-80D present therein and previously described. A qualified technician will also recognize that information file card 24 can be kept in place in a seat 30A-30D by omitting one of the cover 28, the notch 88 and the elevation 80A-80D. Similarly, the information file card 24 could be kept in place by adding lateral margins to support 22 or by using a combination of the elements previously described. These same principles apply to support 200, whose joints 260A-260D could vary in shape, number, as well as position. Similarly, information file card 24 can be kept on support 200 in any suitable fashion.

Information file card 24 is divided into a plurality of cells 58A-58F and 100, which are generally of uniform size and are arranged into a single row. Since the information file cards are generally uniform, only one information file card 24 will be the object of the present description. A qualified technician will however recognize that this description generally extends to all the information file cards provided for in system 20. A first cell 100, located at the left end 96 of the information file card 24, preferably displays information relating to the identity of the patient, for example his surname, name, age, sex, as well as the entire period during which the medication must be administered. This information allows the person in charge of administering the medication to establish the entire period of time during which the information file card 24 must remain on support 22, as will be described in detail hereinafter. The other cells 58A-58F of information file card 24 each represent a period of time, in a chronological order from left to right of information file card 24. All those remaining cells 58A-58F cover the entire day during which the patient resides in the institution and in which he must be administered the medication. The cells 58A-58F preferably represent periods of the early morning 58A, morning 58B, lunch 58C, afternoon 58D, dinner 58E and bedtime 58F, to correspond with cells 68A-68F of the identification band 66. A technician skilled in the art will understand that the period of time represented by a cell may be adapted according to the needs associated with the administration of medication and comprises a period of a day, a day, a week, a month, a year or any other period of time during which a patient would reside in an institution whose responsibility consists in administrating a medication to that patient. Each cell 58A-58F of the information file card 24 comprises a specific color and at least on visual symbol 102 and 104 allowing to distinguish the cell corresponding to a period of the day from the cells corresponding to other periods of the day.

The color of each cell 58A-58F of the same information file card 24 is substantially distinct from the color of the adjacent cells in order to facilitate in distinguishing between the different periods of the day during a quick examination of the information file cards 24 disposed on support 22. The visual symbol 102 and 104 and the color of cells 58A-58F which represent a same time period on the information file cards 24 for different patients, are preferably uniform and correspond to the color of the cell which correspond to that period on the identification band 66 of plate 26. When the information file cards 24 of many patients are placed on support 22, they define a matrix of rows and columns, each column having a typical color which corresponds to a given period (FIG. 2).

The symbols 102 and 104 which identify the period of the day are at least one of the designs representing a sun 102 and a moon 104, whose position varies within the cell, according to the time of the day. By way of example, the cell which corresponds to the morning period 58A, includes a sun symbol 102, which is positioned in the lower left corner of the cell 58A, while the cells corresponding to the dinner period 58E, include the image of a moon 104 in its upper left corner and the drawing of a sun 102 at its lower right corner (FIG. 9). A qualified technician will recognize that many variations in the nature, shape, dimension and position of the symbols may be brought about while preserving functionality. This same technician will also recognize that the presence of such symbols is not required for the system 20 to remain functional and that many visual characteristics may replace the symbols and colors of cells 58A-58F and 68A-68F to make management of administering the medication easier.

Each cell 58A-58F of the information file card 24 displays information concerning the administration of medication 112 to the patient for the corresponding period of time, if necessary. During a given period of time when no medication have to be administered to the patient, cell 58A-58F of the information file card 24 displays no information concerning the administration. The information concerning administration 112 includes, but is not limited to the name of the medication, a symbol permitting identification of the type of medication to be administered, the time at which the medication are to be administered, the dosage, the mode of administration of the medication and the period during which the medication are to be administered to the patient. The information concerning the administration of medication 112 is preferably printed by a pharmacist on the information file card 24 when he generates a main file card 114, such as will be described in detail hereinafter.

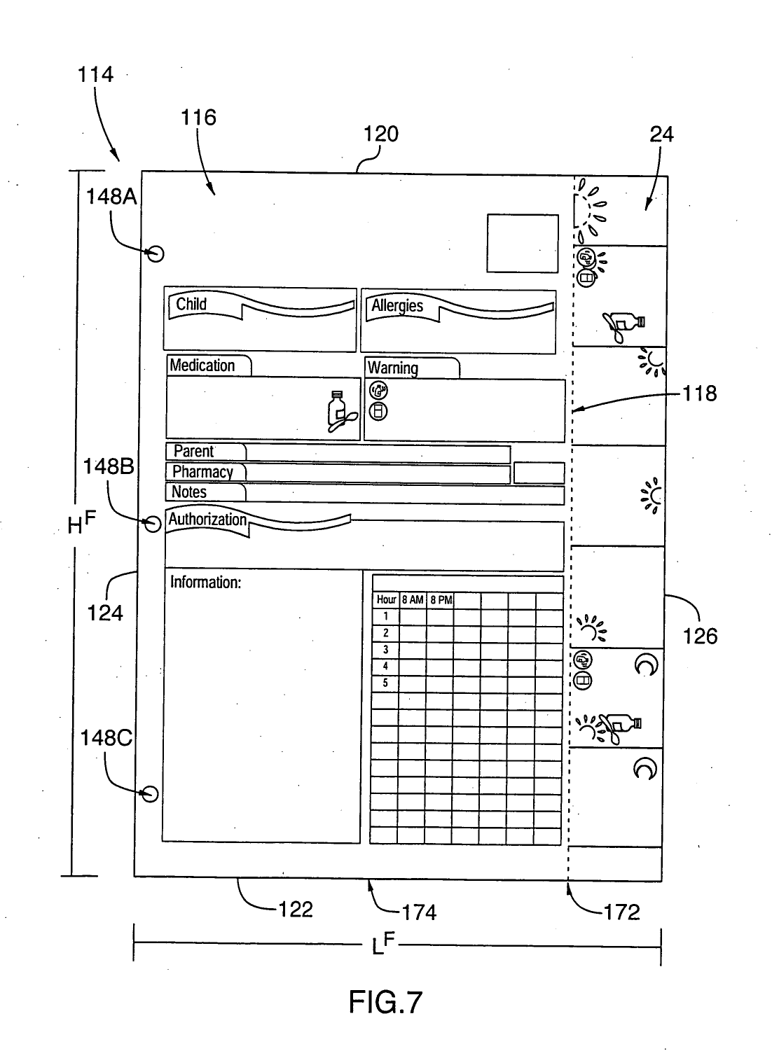

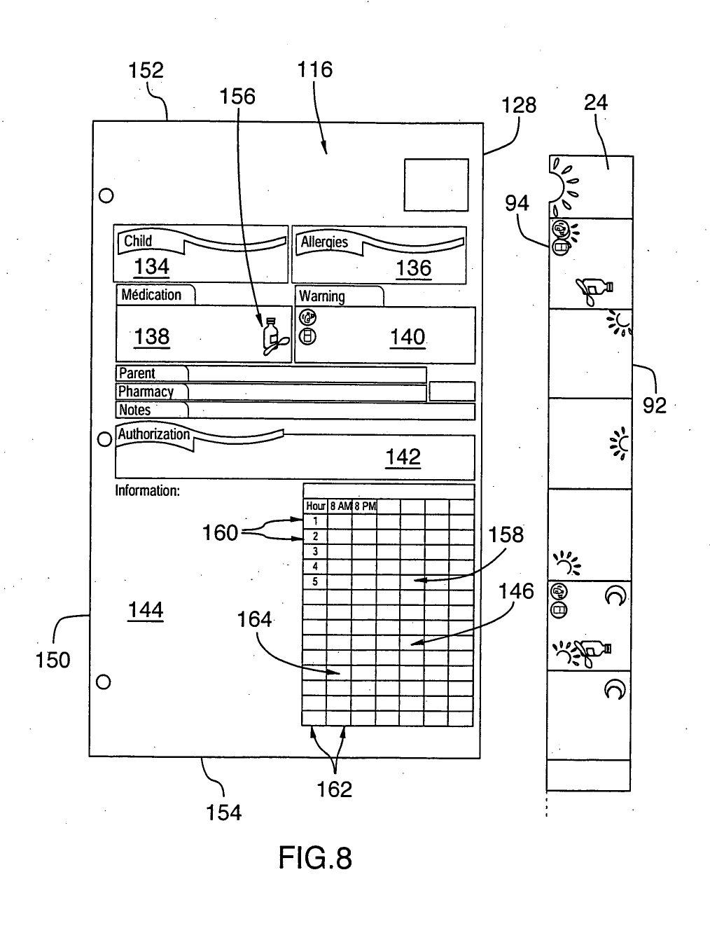

The main file card 114 includes the information file card 24 and an indexable file card 116, these cards being defined by a perforated line 118. According to an exemplary embodiment, the information file card 24 is detached from the indexable file card 116 (FIGS. 7 and 8) before being placed on support 22. The main file card 114 allows a pharmacist to simultaneously generate the information file card 24 and the indexable file card 116 on a single file card. The main file card 114 generally takes the form of a sheet, preferably a sheet of paper. The main file card 114 comprises an upper end 120, a lower opposite end 122, a left side end 124 and a right side end 126, which define a main file card 114 of rectangular shape having a width L^{F} defined by left and right ends 124 and 126, and a height H^{F} defined by upper and lower ends 120 and 122. The width L^{F} and the height H^{F} of the main file card 114 preferably correspond to the width and the height of a sheet of paper of standard size, and more preferably to that of a letter size sheet of paper (216 by 279 mm or 8½ by 11 inches). One skilled in the art will recognize that the main file card may be made of any other suitable material, such as plastic and cardboard, and that its dimensions may be adapted to correspond to the needs of the users.

The information file card 24 and the indexable file card 116 of the main file card 114 are preferably attached to one another along their sides 94 and 128, by means of a perforated line 118. The perforated line 118 extends from the upper end 120 to the lower end 122 of the main file card 114. The perforated line 118 is located in an intermediate region 172 between the center of the main file card 114 and its right side end 126. The perforated line 118 allows a user to separate the information file card 24 and the indexable file card 116 from one another without requiring a tool. A qualified technician will recognize that the perforated line may be replaced by a dotted line along which a cut may be made to produce the information file card 24 and the indexable file card 116, without affecting the functionality of system 20. Alternatively, the information file card 24 and the indexable file card 116 could be attached together along their sides 92 and 154, the dotted line 118 extending from the left side end 124 to the right side end 126 of the main file card 114.

The indexable file card 116 generally takes the form a sheet, preferably a sheet of paper, divided into a plurality of fields 134, 136, 138, 140, 142, 144 and 146, which will be described below, and including perforations 148A-148C allowing it to be placed in a loose leaf binder of standard format. The indexable file card 116 comprises a left side end 150, which corresponds to the left side end 124 of the main file card 114 when the indexable file card 116 is attached to the information file card 24 and its right end 128, defined by the perforated line 118 of the main file card 114. The indexable file card 116 also includes an upper end 152 and a lower end 154, which correspond to the upper and lower ends 120 and 122 of the main file card 114, respectively, when the indexable file card 116 and the information file card 24 are attached together, the upper and lower ends 152 and 154 of the indexable file card 116 then defining a height corresponding to height H^{F}.

Each field 134, 136, 138, 140, 142, 144 and 146 of the indexable file card 116 displays distinct information which is pertinent to the administration of medication to the patient. A first field 134 allows for the identification of the patient and displays information concerning the patient, such as his name, his address, his telephone number, his birth date, his age, his gender and his weight. A second field 136 displays the patient's allergies, which can comprise allergies to medication, food allergies, allergies to insect bites and any other allergy which could affect the patient during the period in which he is lodged at the institution.

A third field 138 describes the medication to be administered to the patient, such as the name of the medication, its concentration, the dosage, the name of the physician who prescribed the medication, the date of prescription and the period of time during which the medication is to be administered to the patient. The third field 138 may also include a symbol 156 which represents the form of the medication to be administered to the patient. By way of example, a symbol representing a bottle and a spoon may be used to represent a medication in syrup form. A symbol which represents a vaporizer could be used for a medication in aerosol form, while a symbol which represents a capsule could be used to illustrate a medication in the form of tablet, capsule, compressed tablet or pill.

A fourth field 140 displays information concerning certain advisory cautions with respect to the medication. Among other things, the fourth field 140 may display information regarding storage of the medication, such as the storage temperature, the sensitivity of the medication to light and the expiration date of the medication. The fourth field 140 may also display information regarding precautions to be taken before or during administration of the medication, such as stirring the medication well before proceeding to its administration or administering to the patient with food, or further still avoiding certain activities during the period within which the medication is being administered, such as alcohol consumption, driving a vehicle or exposure to the sun. The advisory cautions of the fourth field 140 may alternatively include the main side effects of the medication, such as dizziness, lack of appetite, fatigue, wakefulness or any other side effect capable of influencing the life habits of the patient.

A fifth field 142 of the indexable file card 116 displays a consent according to which a guardian of the patient, if necessary, authorizes the person in charge of administering the medication at the institution where the patient is being treated, to administer the medication to the patient.

A sixth field 144 displays additional and detailed information concerning the medication. This additional information includes in particular the nature of the sickness or the problem for which the medication is being administered, the length of time that is required before its effects are perceptible, the side effects of the medication, including those which may happen less frequently, advice regarding the administration of the medication and any other information generally found on the medication chart generally given by pharmacists.

A seventh field 146 includes a schedule for the administration of the medication 158 which comply with the requirements of governmental agencies in connection with the administration of medication at day cares. The administration schedule 158 consists of rows 160 and columns 162 defining cells 164. Each row 160 corresponds to a day during which the medication must be administered, while each column 162 corresponds to each of the hours when the medication must be administered. Once the medication has been administered, the person in charge put his initials on cell 164 which corresponds to the day and the hour 162 when the medication was administered. A qualified technician will understand that the number of fields and the information displayed on indexable file card 116 may be adapted to specific circumstances. By way of example, indexable file card 116 could comprise additional fields for the name and the telephone number of relatives and of the pharmacy as well as important notes, to be displayed in a prominent fashion.

The perforations 148A-148C and the perforated line 118 are preferably made on the main file card 114 before obtaining it from the pharmacist. Similarly, the cells of information file card 24 and the symbols 102, 104, also including fields 134, 136, 138, 140, 142, 144, 146 of indexable file card 116 and the different colors found on information file card 24 as well as on indexable file card 116 are printed on the main file card 114 before providing the same to the pharmacist.

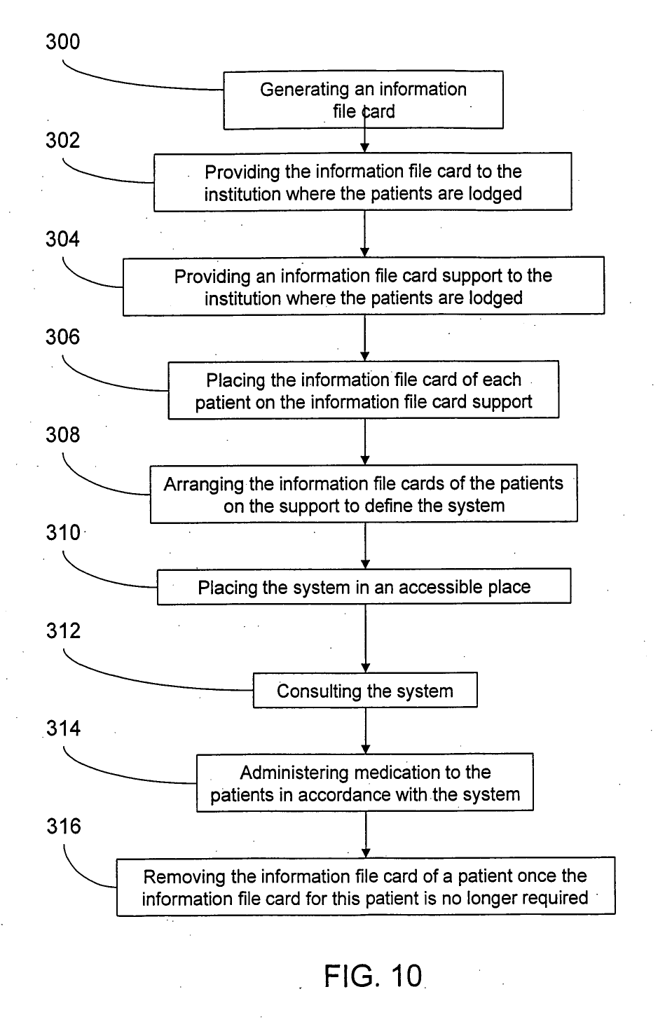

According to an embodiment, there is provided a method for managing the recurring administration of medication to a plurality of patients under treatment in a same institution. Now referring to FIG. 10, during step 300, an information file card is generated for each and all patients on the basis of information compiled for each patient. The compilation of information for each patient is preferably carried out by means of a computerized database. The database is managed by a computer software, which is preferably compatible and interfaceable with the systems of patient file management already in place in different pharmacies. The software is provided to the pharmacists and allows for the printing of information file cards 24 or main file cards 114. The database managed by the computer software is designed to include information concerning the patient, which information includes, but is not limited to, the name of the medication, the name and the address of the patient, the name of relatives, the name of the treating physician, the name of the person in charge of administering the medication during the care period, the birthday, the gender, the weight and the allergies of the patient. The database can also comprise data concerning the monograph of the various medication on the market, said data including the name of the medication, its potency, its concentration, the form in which it is available (liquid, solid, aerosol), its mode of administration, its dosage, the prescribing physician, the methods of storage, the side effects and warnings. Data relating to the monograph of the medication are preferably compiled in the database by the supplier of the computer software, before distributing it to pharmacists. The information concerning the monograph is preferably reproduced on the information file card 24 or on the main file card 114 when the latter is generated, as will be described hereinafter.

The pharmacist obtains information concerning the patient after the latter has consulted his physician or another health specialist. The physician or the health specialist prescribes a medication to his patient. The patient or his guardian gives the prescription to the pharmacist, who compiles the information concerning the prescription in the database.

The software provided to the pharmacist is preferably configured to generate the information file card 24 or the main file card 114. A sheet on which the information file card 24 or the main file card 114 will be generated is first provided to the pharmacist, preferably by a printer or a distributor. The sheet preferably includes fields 134, 136, 138, 140, 142, 144, 146 of the indexable file card 116, the cells 58A-58F of the information file card 24 and symbols 102, 104 which are pre-printed on the sheet. The sheet also comprises color fields in each cell 58A-58F and 100 of the information file card 24. The sheet is given to the pharmacist, who will use it as a base for printing the information which is specific to the patient and to the medication which must be administered to him, thereby generating an information file card 24 or a complete main file card 114.

In step 302, the generated information file cards are provided to the institution where the patient is being treated. The generated information file card 24 or main file card 114 is given to the relatives or guardian of the patient, at the same time as the medication. The relative or guardian of the patient then gives the main file card 114 to the person in charge of administering the medication in the institution where the patient is lodged, preferably at the same time as the medication to be administered to the patient. The generated information file card 24 or the main file card 114 could also be given directly to the person in charge of administering the medication. By way of example, a pharmacist who practices in a hospital environment could give the information file cards 24 of the patients directly to the departments in which these patients are hospitalised. Alternatively, the sheets on which the information file cards 24 or the main file cards 114 are generated could be given directly to the person in charge of administering medication in the institution in which the patients are treated. The information compiled and generated by the pharmacist following reception of the prescription of the patient could be transmitted electronically to the person in charge of administering the medication, and the latter could directly print the information file card 24 or the main file card 114 in the institution where the patients are treated.

During step 304, an information file card support is supplied to the institution where the patients are lodged. The information file card support may be given to the institution before reception of the information file cards 24. The supports 22 and 200 are preferably provided to the institution where the patients are lodged at the same time as a loose leaf binder in which the supports 22 or 200 can be stored. The loose leaf binder may comprise a series of thumb indexes under which are listed, for example, information concerning use of system 20, the different medication and the administration of medication to non-autonomous patients, the indexable file cards 116 of each and all patients and the system 20. Alternatively, an information file card support could be provided to the institution where the patients are lodged at the same time as a base required for displaying system 20 in a location that is visually accessible.

Upon receipt of the information file card 24 or the main file card 114, the person in charge of administering the medication places information file card 24 on the information file card support (in step 306). In the case where a main file card 114 is supplied to the institution where the patients are treated, the person in charge of administering the medication separates the indexable file card 116 from the information file card 24 by folding the information file card 24 on the indexable file card 116 along the perforated line 118 so as to weaken the bonds attaching the information file card and the indexable file card together. Information file card 24 is detached along the perforated line 118. The person in charge of administering the medication is therefore in the presence, on the one hand, of an indexable file card 116 and, on the other hand, of an information file card 24.

In order to place the information file cards in the support 22, the person in charge of administering the medication opens the transparent cover 28 of the support 22 by raising its lower end 86, in a manner to have access to the seats 30A-30D, and thereafter places the information file cards 24 of each and all patients in one seat 30A-30D. With respect to support 200, the person in charge of the medication opens a pocket 206A-206D and slides therein the information file card 24 of a patient between each lateral ends 252A-252D and 254A-254D via opening 258A-258D.

During step 308, the person in charge of administering the medication aligns the information file cards on the support so as to obtain a matrix having a plurality of rows and columns, while being careful to match the notches 88 of the information file cards 24 with the elevations 80A-80D and aligning the side edges 96 and 98 of the information file cards 24 with the side ends 36 and 38, respectively, of plate 26. Thus, the cells 58A-58F of the information file cards 24 are aligned with the corresponding cells 68A-68F of the first projection 40 to define columns 170A-170G of a matrix, each and all of the columns 170A-170G having a distinct color and corresponding to a time interval. Once the cards have been aligned, the cover 28 is closed back on plate 26, while being careful to suitably fix the fastener 76 of the cover 28 to the complementary fastener 90 of the plate 26, in order that the information file cards 24 are kept in place in seats 30A-30D. When support 200 is used, the notch 88 of the information file card 24 is arranged so as to correspond with the semi-circular joint 260A-260D of the pocket 206A-206D.

In step 310, the person in charge of administering the medication places the support comprising the information file cards of the patients in a location that is accessible, such as in a loose leaf binder. The system 20 is preferably placed on top of the different thumb indexes and the documents placed in the loose leaf binder so that the person in charge of administering the medication has quick access to the system 20. In this context, the person in charge of administering the medication places the system 20, i.e. the support 22 comprising the information file cards 24, in the loose leaf binder by inserting each ring of the loose leaf notebook in one of the perforations 78A-78C of the perforated section 50 of support 22. The support 200 comprising the information file cards 24 is inserted in the loose leaf binder in the same way.

When a main file card 114 is given to the institution where the patients are treated, the person in charge of administering the medication places the indexable file card 116 in a location that is accessible. By way of example, when the system 20 is placed in a loose leaf binder, the indexable file card 116 of each and all patients can be placed in the same loose leaf binder, and each indexable file card 116 is listed under a different index tab which corresponds to a single patient.

Alternatively, the system may be placed on a vertical surface. In the case where the support 22 or 200 is provided with magnetized bands, the system 20 may be placed on a vertical metallic surface, such as the door of a refrigerator. A technician skilled in the art will realise that the system may be adapted so as to be placed on any other suitable vertical surface, such as a wall or a door. In the case where the information file card support is provided with a base, the system may be placed on a horizontal surface such as a table or a countertop.

During the day, the support comprising the information file cards is consulted by a person in charge of administering the medication at a given time, in order to obtain information concerning the administration of the medication to each and all the patients (in step 312). In the case where the person in charge of administering the medication requests more detailed information on the medication to be administered to a patient, he consults the indexable file card 116 of the patient under the index tab containing same.

In step 314, the medication are administered to the patients in accordance with the information displayed on the support comprising the information file cards. Once a medication has been administered to the patient, the person in charge places his initials in the managing schedule 158 of the indexable file card 116, in cell 164 corresponding to day 160 and at the time 162 when the medication was administered.

In the case where the medication no longer needs to be administered to a patient, the person in charge of administering the medication removes or take away the information file card of this patient from the support (in step 316).

Although the invention has been described in connection with specific embodiments, it will be understood that it may be subject to other modifications and an object of the present application is to cover all variations, utilisations or adaptations of the invention following, in general, the principles of the invention and including differences with the present disclosure which would be known or used in normal manner in the art under consideration by the present invention and in such a manner that they could be applied to the essential characteristics described above, and in the scope of the claims described hereinafter.

1. A method for managing the periodic administration of medication to a plurality of patients lodged in a same institution, said method comprising:
providing an information file card for each said patients, said information file card being divided into a plurality of cells, at least some of said cells corresponding to a time interval and displaying information concerning the administration of said medication to said patient during said interval;
providing a support on which a plurality of information file cards can be placed, said information file cards being adapted to be aligned to define a matrix having a plurality of rows and columns;
arranging said information file cards on said support, said plurality of cells of each said information file cards defining one of said rows and columns of said matrix.

2. The method according to claim 1, wherein the step of arranging said information file cards includes the step of aligning said information file cards in such a manner that said cells of said information file cards which correspond to one said intervals are aligned with respect to one another.

3. The method according to claim 1, wherein the step of providing said information file card includes the step of compiling said information concerning said administration of said medication to said patient in a database.

4. The method according to claim 3, wherein said database includes at least one of the following data: (a) data relating to concerning the mode of administration of said medication; (b) data concerning the side effects of said medication; (c) data concerning the physician responsible for prescribing said medication; (d) data concerning the physical characteristics of said patient; (e) data concerning the guardian of said patient; and (f) data concerning the consent of said guardian for a third person to administer said medication to said patient.

5. The method according to claim 3, wherein the step of providing an information file card includes the step of generating said information file card from said information compiled in said database.

6. The method according to claim 5, wherein the step of generating said information file card includes the step of printing said information file card on a sheet.

7. The method according to claim 6, wherein:
said sheet includes an indexable portion, said indexable portion being detachable from said information file card; and
said step of providing an information file card includes the step of detaching said information file card from said indexable portion.

8. The method according to claim 1, further comprising the step of administering said medication in accordance with said information contained in said cells of said information file cards corresponding to said interval.

9. The method according to claim 1, wherein said patients are children.

10. The method according to claim 1, wherein said institution is selected from a day-care center, a nursery or a childcare center.

11. A system for managing periodical administration of medication to a plurality of patients being lodged in a same institution, said system comprising:
a plurality of information file cards, each said information file cards corresponding to one said patients and being divided into a plurality of cells, at least some of said cells corresponding to a time interval and displaying information concerning administration of the medication to said patient during said interval,
a support on which a plurality of information file cards can be disposed, said information file cards capable of being aligned in a manner to define a matrix having a plurality of rows and columns; said plurality of cells of each said information file cards defining one said rows and columns of said matrix.

12. The system according to claim 11, wherein, when said information file cards are arranged on said support, said information file cards are aligned in such a manner that said cells of said information file cards corresponding to one said interval are aligned with respect to one another.

13. The system according to claim 12, wherein each said row corresponds to one said patient and each said column corresponds to one said interval.

14. The system according to claim 12, wherein each said row corresponds to one said interval and each said column corresponds to one said patient.

15. The system according to claim 11, wherein said support includes a base on which said information file cards can be arranged.

16. The system according to claim 15, wherein said base is rigid.

17. The system according to claim 15, said support additionally comprising a plurality of seats, each said seat being adapted to receive one said information file card.

18. The system according to claim 17, said base including a plurality of spaced-apart longitudinal projections, said adjacent longitudinal projections defining said seats.

19. The system according to claim 11, wherein said information file card is printed on a sheet.

20. The system according to claim 19, wherein said sheet is made from a material selected from the group of materials consisting of: (a) paper; (b) cardboard; and (c) plastic.

21. The system according to claim 19, further including a sheet having a first portion corresponding to said information file card and a second indexable portion, said indexable portion being detachable from said information file card.

22. The system according to claim 11, said system further comprising a device for aligning said information file cards, said aligning device comprising a first portion associated with said support and a second portion associated with said information file cards, said first and second portions collaborating with one another to allow the alignment of said information file cards.

23. The system according to claim 11, wherein said cells display at least one visual characteristic which is specific to each said time interval.

24. The system according to claim 11, wherein said time interval includes a period of the day, the week, the month or the year.

25. The system according to claim 11, wherein said patients are children.

26. The system according to claim 11, wherein said institution is selected from a day-care center, a nursery or a childcare center.

27. A display for managing periodic administration of medication to a plurality of patients being treated in a same institution, said display comprising:
a plurality of information file cards, each said information file cards corresponding to one said patients and being divided into a plurality of cells, at least some of said cells corresponding to a time interval and displaying information concerning administration of the medication to said patient during said interval,
a support on which a plurality of information file cards can be disposed, said information file cards capable of being aligned in a manner to define a matrix having a plurality of rows and columns; said plurality of cells of each said information file cards defining one said rows and columns of said matrix.
